(19) United States
(12) Patent Application Publication
(10) Pub. No.: US 2025/0063019 A1
(43) Pub. Date: Feb. 20, 2025

(54) TRANSPARENT ROUTED UNIFIED VIRTUAL PRIVATE CLOUD

(71) Applicant: THOMAS G FEHSE, Montville, NJ (US)

(72) Inventor: THOMAS G FEHSE, Montville, NJ (US)

(21) Appl. No.: 18/752,569

(22) Filed: Jun. 24, 2024

Related U.S. Application Data
(60) Provisional application No. 63/523,106, filed on Jun. 25, 2023.

(51) Int. Cl. H04L 9/40

(52) U.S. Cl. CPC H04L 63/0236; H04L 63/0281; H04L 63/166

(57) ABSTRACT

Methods and systems for setting up a virtual private cloud can involve providing redundant or nested security layers including a local firewall within a provider firewall. In addition, a virtual private cloud proxy server can be provided with access to a data network through the local firewall and provider firewall. In addition, the virtual private cloud proxy server can be configured in coordination with the local firewall and the provider firewall to enable transparent proxying, wherein TCP/UDP traffic is redirected to a local port, with support interchangeable use IPV4 and IPV6, to selectively allow access to all system within the provider firewall. Furthermore, access can be provided to a set of rules, whereby internet packet traffic is filtered and then directed to and from clients within the local firewall based on a list of rules.

### FIELD OF THE INVENTION

Embodiments are generally related to information technology, and the security of data networks and network accessible devices. More particularly, the embodiments are related to the provision of a protected network comprised of other networks, systems and/or devices, regardless of location ISP, or internet service provider. The embodiments are related to providing a transparent routed unified virtual private cloud (“TruVPC”).

### BACKGROUND

Many companies have been started and continue to operate “in the cloud”. Cloud-based companies do not typically have or require a physical building for housing servers. Cloud-based company employees can be located all over the world. Everything from company laptops to cloud servers are typically connected to the public internet. Given the foregoing, what is needed is integrated protection that protects laptops, desktops, Wi-Fi Networks, and everything that will be hosted from the public cloud. Cloud-based companies need to protect their intellectual property (IP) and data associated with its employees, partners, customers, and anyone else who has entrusted the company with their data and IP. Cloud-based companies need a safe place to conduct development, without the need to worry about security. These entities essentially need improved means to protect production servers.

The problem encountered by Cloud-based companies is that everything is on the public internet. People are people, and mistakes can and will occur. Controlling and protecting against an attack that is dynamic and impacted by changes outside of user control is exceptionally difficult. Offering data and IP protection is difficult under the best of circumstances and is made exponentially harder by unknown factors introduced by both good and bad actors. The following example activities can compromise security: a user with physical access to their laptop can potentially do anything to affect the security of that laptop; removing/changing passwords; opening network access; a user with superuser access can install or remove software; some users may act with a willful disregard for the security of their system or others; social engineering may also be used to compromise security; employees may even use their approved access to copy IP/data for reasons that are not authorized.

There is a lack of effective or existing solutions for providing data security for cloud-based entities. The present inventor has spent time searching for a product that could provide everything that is needed to provide ease of use and ample data security. What was found is:
Frameworks and software to “help” operators of cloud-based companies create/build and manage everything themselves.
   The frameworks include things like Remote Monitoring and Management (RMM) and overlay networks.
   These frameworks assume a user has knowledge they may not have.
   These frameworks often require rather detailed configurations just to get them to offer any protection.
Generative security tools, complex policy management, and natural language policy generation/management all have the same issue: they help with rules and require addition things to manage/monitor and enforce those rules.
Vender specific solutions.
   Some companies may offer protection for their product, but that protection is only for their products.
Limited End Point protection solutions.
   Some companies have software to protect, for example, a Windows system, but that does not guarantee any protection for anything else and may not even protect the Windows system.
   Some end point solutions are downright deceptive and don't appear to offer any protection (only offered an illusion of protection).
Vulnerability scans that flood users with false positives.
Consultants and other companies that will create a custom infrastructure for its customer.
   Built completely from scratch, based on customer requirements.
   This is very manual and can be very expensive.

### SUMMARY

To overcome shortfalls in the prior art, the present inventor has created a transparent routed unified virtual private cloud (TruVPC), which enables the creation of a protected network comprised of other networks, systems, or devices, regardless of location, ISP, or internet service provider. TruVPC protection can be integrated with third party products inside and outside of the network. Transparent protection enabled by TruVPC can assure that user within the Unified Virtual Private Network do not notice it's there. Users should be able to link your cloud VPCs and on-premises LANs. Optionally linked with an endpoint solution for complete control. It is a feature of the embodiments that users should not need to mess with proxy configurations. Features should appear to work like they are connected to the internet, with control over their local firewire.

Features of the embodiments to provide a new solution with security and functionality can uniquely aggregate features selected from the following:
An internal company network or private project network.
   These networks can have the feature typical of a traditional internal network.
   Everything within the network can be directly accessed from the outside world.
   Servers that can talk to the outside world will need a hole in the firewall.
   Unlike a traditional internal network, users can have multiple protected networks and can situationally connect to those networks.
The protected networks would remain isolated from each other, but you would be able to connect to both.
The protective network can include hosts from various cloud providers, office/Wi-Fi networks, and directly connected endpoint systems (like laptops and desktops).
The solution can be an integrated solution.
   Cloud Providers, network hosts, and various software packages can work together to secure the protected network.
It can be possible to do easy and fully automated deployment of everything needed for complete protection.
   Advanced manual configuration options can exist, but everything can also be as automated as possible.
The security in general can be transparent. Other than potentially using VPN or software to use a network proxy, the security should not impact the user in any negative way.
Redundant levels of protection.
   Where possible, at least 3 levels of redundant protection can be provided.
      Example: a port might be protected by the firewall on the local server, its edge server, and the cloud provider.
      Example: Data should be encrypted at the service level, over the overlay network, and to/from the client system.
      Example: system identifies confirmed with a 3^{rd} party authority, a private authority, and with local system keys.
Passive safeguards.
   If the security of the system is for example removed, the passive behavior of the solution can isolate this system.
      By passive it means no active changes should be needed on the part of the solution to deal with the threat.
      By isolate, it means to either not allow the compromised system to connect to and or communicate with other systems on the protected network. If the compromised system requires the protective network to communicate with the internet, it can lose access to the internet.
Self-testing, automated penetration testing and other security scans.
   Nothing is ever trusted. Anything, including service providers and other 3^{rd} parties can be compromised. Scans can be done to verify behaviors match what is expected. For example: if port 80 is not open, a scan should not see 80 and should not be able to talk to a webserver.
Threat monitoring and mitigation.
   The system can provide active threat monitoring and automated mitigation.
Incursion detection and mitigation.
   The system can provide active incursion monitoring and automated mitigation.
Zero knowledge. Where possible, zero knowledge proofs can used. For example: the solution should not need to know a user's password, but the user should be able to prove to the solution they know their own password.
Zero trust. Always verify everything.
   Things like JWT tokens can be used to pass information, but tokens and access always need to be verified.
Network traffic around the protected network needs to be routed and protected.
   Often communication between provider regions, and all communication between providers goes across the public internet.
      This communication can be seen and intercepted by 3^{rd} parties.
         Every effort needs to be taken to protect this vulnerable data.
      Network data within a cloud provider may not be private and point to point encryption even within a provider may be needed.
   Every effort should be made to protect against DNS lookup leaks.
Network traffic to the outside world needs to be routed and protected.
   Example: IP addresses or types of communication may be blocked to stop a threat.
   Example: Access to a site like Google, may be routed to an edge server in a country with unrestricted access to Google.
Reduce attack surface.
   Edge servers should be the only truly publicly accessible targets.
      Scripted scans, DDoS attacks, and everything else should happen on the hardened Edge Servers.

Other advantages of the embodiments are:
Reduced Cost
   Some data paths cost more than others. Digital Ocean for example, data sent on the private interface is free, data sent on the public interface is not.
   Bugs, unexpected issues, or bad actors can lead to very large, unexpected costs.
      An intern tested scaled might make a mistake costing thousands of dollars in usage costs.
      A bad actor might sign up for compute services to mine cryptocurrency with no intention of paying, costings and possible hundreds of thousands or more in costs.
Point to point data route control.
   With the IoT, if a user can control the route, then the user can vastly increase its security.
      For example, where a user's LIFX lightbulb has access to the user's Wi-Fi and LAN, if a third party hacks the user's LIFX lightbulb, then they could also gain access to a user's LAN.
      If a user can control the route, the user can eliminate this issue. If the user only allows the LIFX lightbulb to talk to *.lifx.com domains, the user makes it harder to compromise and if it is compromised it would be limited to the lightbulb.
      If an attacker bypasses network protections and connects with a Bluetooth connection, controlling the path still adds protection, the attacker may be able to control the lightbulb, but attempts to access the network outside would be seen in the drop logs (and the drop logs can be used to detect an incursion in progress).
Issues related to State sponsored cyberthreats.
   Ability to avoid being monitored or having some connections blocked.
      If, for example, the user was a newspaper organization, it might want the ability to have a global Intranet, which is secure.
         The organization might need some of your network traffic to be transformed into a form that will blend into other types of traffic or have the apparent destination of the data changed to something that will get less attention.
Control of IP addresses talking to 3rd party sites, tools, APIs, and applications.
   If the user knows the IP addresses you use, then the user can use whitelists and increase your security.

### BRIEF DESCRIPTION OF THE DRAWINGS

FIG. 1 illustrates a diagram of a transparent routed unified virtual private cloud (TruVPC), in accordance with embodiments;

FIG. 2 illustrates a diagram of redundant or nested security layers, in accordance with embodiments;

FIGS. 3A-3D illustrate a simplified summary of a layer in creation of a TruVPC, in accordance with embodiments;

FIG. 4 illustrates a diagram of context deployment, in accordance with embodiments;

FIG. 5 illustrates a flow diagram and overview of connections with a client transparent proxy, in accordance with embodiments;

FIG. 6 illustrates a flow diagram of connections with a client transparent proxy in further detail, in accordance with embodiments;

FIG. 7 illustrates a diagram of VPC Proxy Server/Edge Server interactions with clients, in accordance with embodiments;

FIG. 8 illustrates a diagram of an office LAN, in accordance with embodiments;

FIG. 9 illustrates a diagram of a LAN firewall, in accordance with embodiments;

FIG. 10 illustrates a diagram of a unified network, in accordance with embodiments;

FIG. 11 illustrates a flow diagram of routing to the internet, in accordance with embodiments;

FIG. 12 illustrates a flow diagram of Routing to System inside of Unified VPC, in accordance with embodiments;

FIG. 13 illustrates a flow diagram of Routing/Interfaces, in accordance with embodiments;

FIG. 14A illustrates a flow diagram of a party being blocked by an external firewall, in accordance with embodiments;

FIG. 14B illustrates a flow diagram of a bypass with a single connection, in accordance with embodiments;

FIG. 14C illustrates a diagram of multiconnection inside and outside external firewall, in accordance with embodiments;

FIG. 15 illustrates a diagram of local DNS resolution, in accordance with embodiments;

FIG. 16 illustrates a diagram of remote DNS resolution, in accordance with embodiments;

FIG. 17 illustrates a diagram of a drop log, in accordance with embodiments;

FIG. 18 illustrates a diagram of end user connection, in accordance with embodiments; and

FIG. 19 illustrates a diagram of whitelisting, in accordance with embodiments.

### DETAILED DESCRIPTION

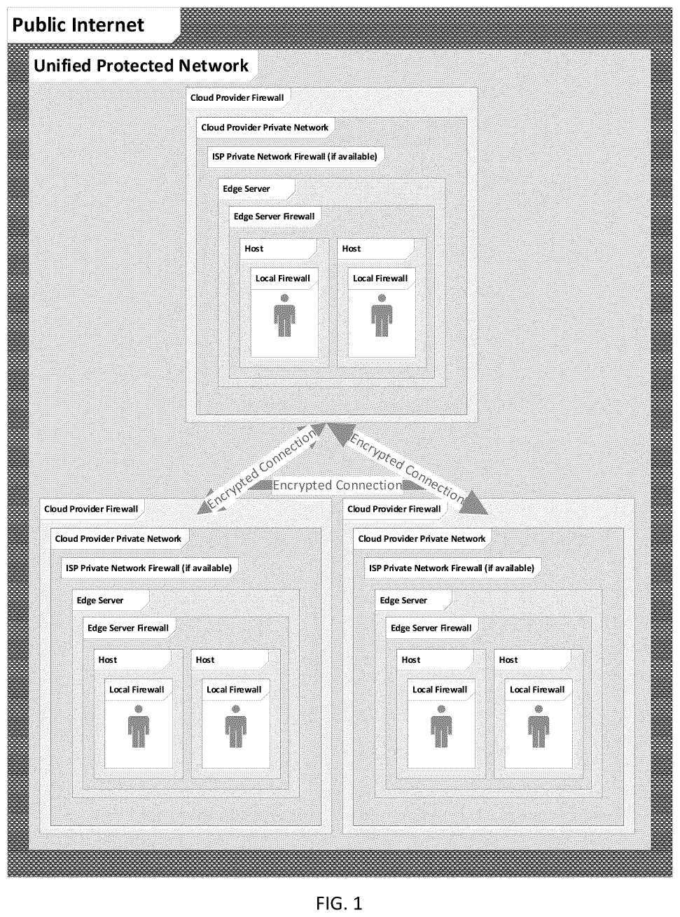

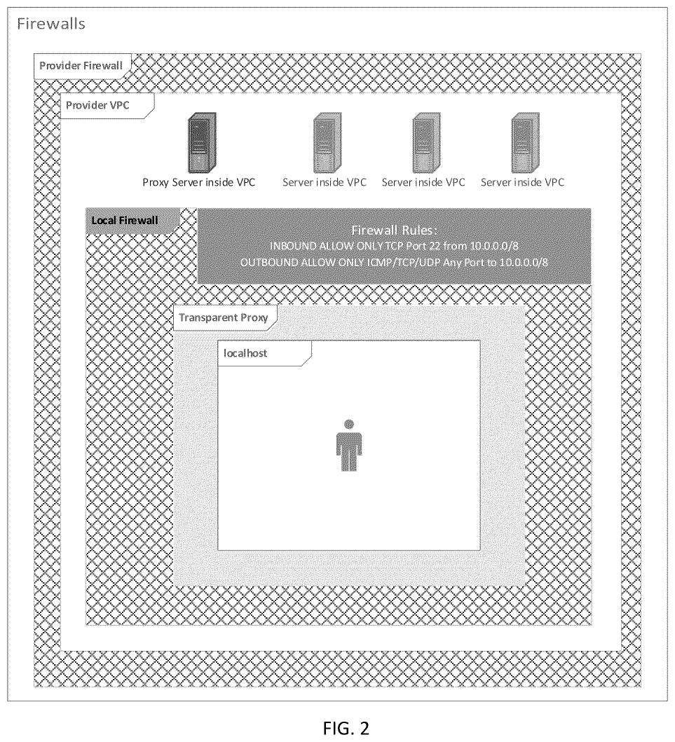

Referring to FIG. 1, components of a TruVPC/Protected Network operating on the public internet are illustrated. Noteworthy pieces for three interconnected users operating over the public internet can include: a cloud provider firewall, a cloud provider private network, an ISP private network firewall (if available, an edge server, and edge server firewall, a user device (host) using a local firewall. Referring to FIG. 2, illustrated is a diagram of redundant or nested security layers. Features can include: provider and local firewalls, firewall rules, provider VPCs, and transparent proxies.

In light of FIGS. 1 and 2, key features or problems solved by the TruVPC are:
It only takes one mistake to compromise your network.
   Anyone from an intern copy and pasting commands from a website or an ISP with an “undocumented feature” can open a hole in your security.
   Users need multiple layers of protection to help stop a hole in one layer from being a bigger issue.
The security should not negatively impact the user. If a user is negatively impacted, they might try to disable the security.
   The security should be largely invisible to the user.
There will be a local firewall on each system. Someone with the appropriate permission can change that configuration.
   An example case of where this would be needed is if a developer wanted to create an internal web server. They can open port 80 and 443. Other users within the protected network will be able to access those ports.
   There can also be policies for what is and is not allowed.
      Compliance violations will trigger security alerts.
      Potentially automated corrective action.
         E.g., Removing firewall changes are not allowed by the policy.
      In extreme cases a system might be auto disabled.
         E.g., If someone creates a script to keep adding the bad firewall rule.
The firewall configurations and VPC configurations will be monitored.
   Configurations outside of what is expected will trigger security alerts.
      Potentially automated corrective action.
         Removing firewall changes that are not allowed by the policy.
      In extreme cases a system might be auto disabled.
There will be a transparent proxy on each system that is being managed.
   The transparent proxy will redirect TCP/UDP traffic to a local port.
   IPV4 and IPV6 are supported, and either or both can be used.
The local firewall may or may not allow access to all systems in the Providers VPC
   There are scenarios where management of all the systems within the VPC is not possible.
      The VPC may be shared or maybe instead of a VPC it is an on-premises network that is shared.
      Or a single system or device on a public connection.
         While this is undesirable it is can be a supported configuration
   If access to the entire VPC is not allowed, only a few whitelisted systems can be used.
   Systems that are not managed will not be on the proxy network would need to communicate with the managed systems as if they were trying to access those systems from the public internet.
      Which would not be possible under most circumstances.

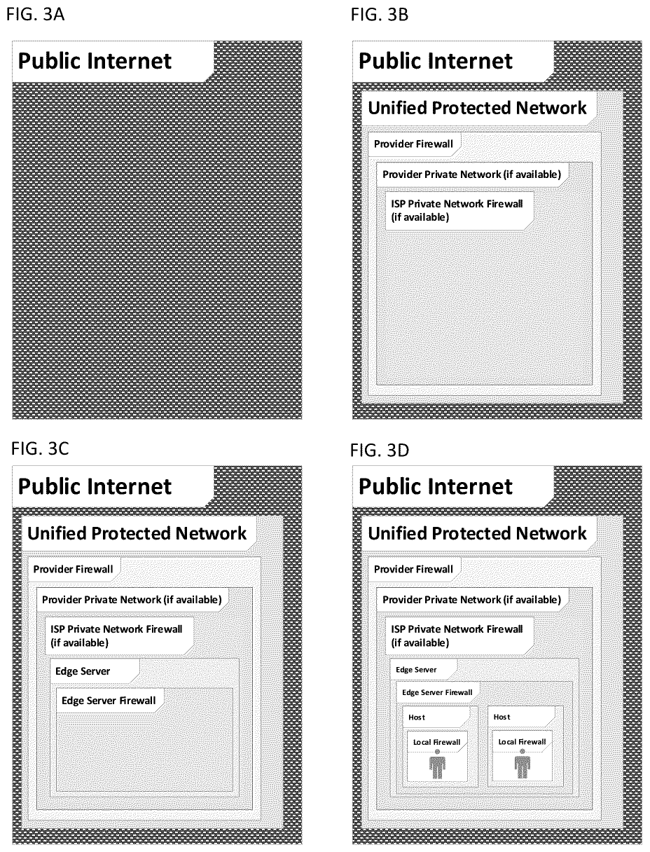

Due to being on being on the public internet, a system can get compromised during its provisioning. To protect against this, TruVPC is deployed in a layered fashion. Referring to FIGS. 3A through 3D, a simplified summary of layer creation for a TruVPC is illustrated.

FIG. 3A is the unsafe public internet.

FIG. 3B an isolated network is created.
a. How the network is isolated depends on the situation.
b. Which it is hosted by a cloud provider or inside of a on premise network, options will vary. Some of the options to create these isolated networks are virtual local area networks (VLANs), firewalls, or other network configurations.

FIG. 3C, once a safer isolated network is created, edge servers will be deployed.
c. Edge Servers have hardened security and are the only servers that allow the possibility of direct internet access.
d. Edge servers also have a firewall, that all traffic to system within the protected network need to go through.
e. Edge servers can talk to other edge servers over an encrypted connection.
f. Edge servers are also able to talk with servers within their network over an encrypted connection.

FIG. 3D, after an edge server is fully online, hosts within the network can connect to the internet through encrypted communications with the edge server.

Provisioning of a host can start before the edge server is online. The system can be put into waiting mode, if it is at a point it needs to talk to the public internet. Once the edge server is fully online, the host will connect to the edge server and complete the deploy process.

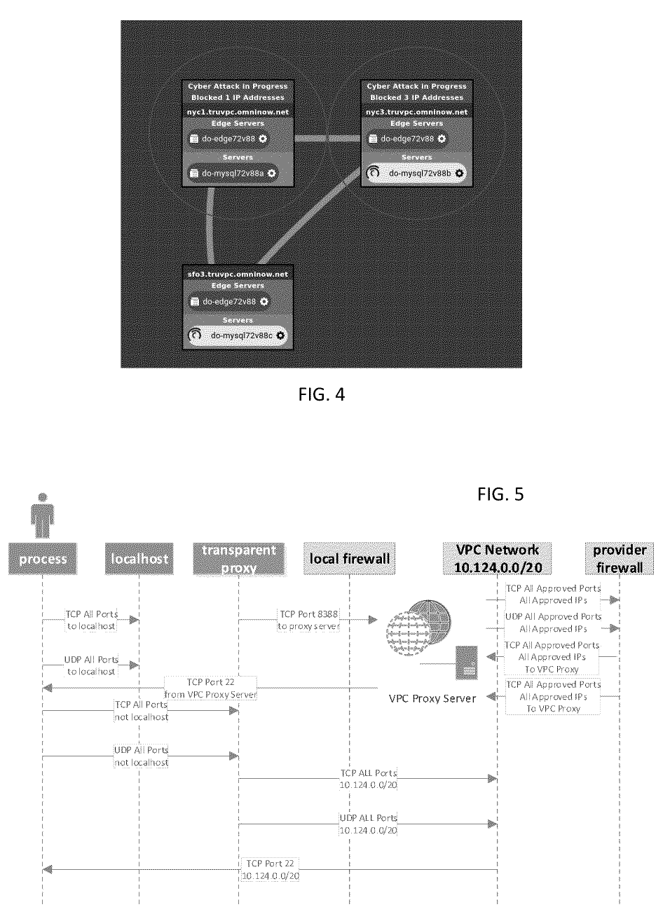

Referring to FIG. 4, Two nodes are shown needing to wait, until other servers that they depend on are online. All three Edge servers (do-edge72v88.nyc1.omninow.net, do-edge72v88.nyc3.omninow.net, and do-edge72v88.sfo3.omninow.net), and the first node of the cluster (do-mysql72v88a.nyc1.omninow.net) needs to be fully online, before additional servers can be added to a cluster.

It is a feature of the embodiments to provide transparent and passive protection. An issue with this is with root level or physical access to a system a user is free to disable or not install/configure security features for the system. For example:

Software developers can be a security threat.
a. Software running in a “development mode” typically has limited security.
b. A developer may try to disable security during development work.
c. A developer may manually configure a system, requiring a manual system deploy, and that system may not be configured with TruVPC.
   There is also an issue with over overzealous and draconian security can make development difficult and encourage users to try to bypass security. Furthermore, the unified network is a collection of potentially physically separate networks, with potentially separate host providers, with no direct connection. A network needs to appear to a user within the network to be a single connected network.

Solutions: With the use of firewalls external to the system/VM/host/server, the system only has access to the local protected network and cannot talk to the outside world. This offered passive protection.
If a user disabled security features, the system may lose its ability to talk to the edge server (cutting it off from the world).
If a system was never added to the edge server's network, the server would function as standalone, and would not have access to the protected network. It would be outside of the network.
   Transparent proxies can also offer a solution. By using a transparent proxy, traffic can be directed to where it needs to go, without it being noticeable in a negative way to the user.

### Examples

A user on a virtual machine, points their browser to https://google.com
   Traffic will be directed to/from google.com, through Edge Server.
A user uses the ssh command to connect to another system on the unified network.
   Traffic will be directed to/from server, using one or more edge servers.

Referring to FIG. 5, illustrated is a flow diagram and overview of connections with a client transparent proxy, in accordance with embodiments. Key features or problems solved are:

The problem being solved is to have the benefits of security offered by the Unified VPC, but without any extra configuration.
a. More configurations are more possibilities of creating holes in your security.
b. The more transparent it is, the less chance of users trying to disable it.

The client transparent proxy is an important piece of Unified VPC.
c. The purpose of the transparent proxy is to get network traffic where it needs to be on the next step in its journey.
   i. Some traffic is going to another network and needs to go to a Local Client Proxy Server.
   ii. Some traffic is going to the VPC.
   iii. Some traffic is going to the localhost.
d. This layer will follow the rules of the firewall.

IPV4 and IPV6 are supported.

UDP, TCP and ICMP are supported

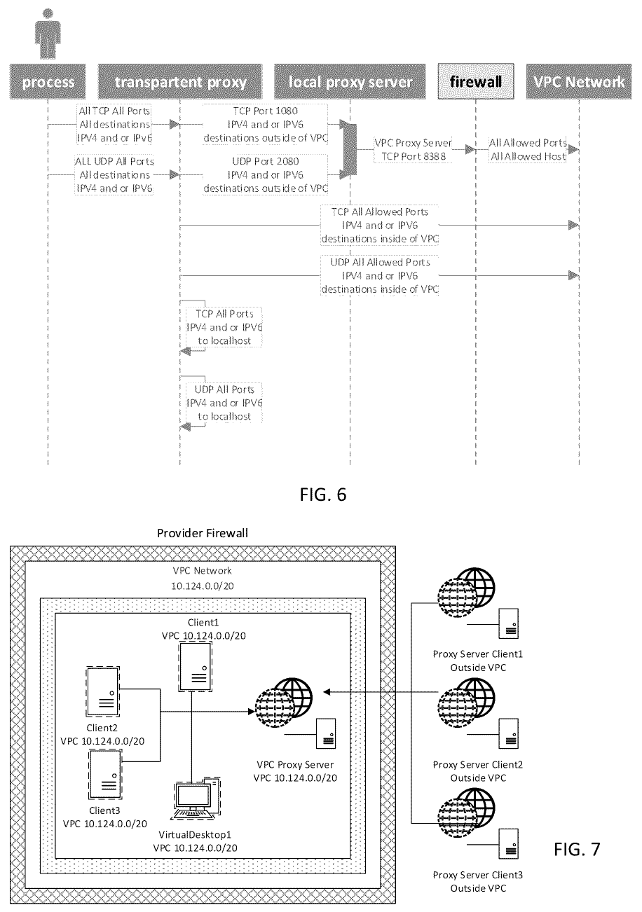

Referring to FIG. 6 illustrated is a flow diagram of connections with a client transparent proxy in further detail. FIG. 6 illustrates:
All traffic will be directed somewhere based on a list of rules.
   The rules can include anything allowed by the IP packet filter rules allowed on the client.
      These rules in general will be defined with a utility on the OS, for example iptables or ip6tables, but may include other ways to configure the rules.
      While the actual rules options can vary these are the major options that can be included in a rule
         IPV4 or IPV6
         Protocol
         TCP
         UDP
         ICMP
         ICMPv6
         And potentially others
         UDP-Lite, ESP, AH, SCTP, MH, etc. . . .
         Source IP with or without mask
         Destination IP with or without mask
         Source Port or Port Range
         Destination Port or Port Range
   The traffic will be routed to the next step or hop for the packet.
      The next step or hop might be to a server port (local or remote)
      Based on the rules the packet might go direct
         Bypassing anything extra added to the route like proxy servers.
         Localhost will be direct.
         Things like the local VPC might also be direct.
         Other examples might include things like whitelisted IP addresses, subnets, ports or port ranges.
      Traffic might be dropped (blocked) as well based on anything blacklisted.
   In general traffic outside of the local VPC will need to go to the Proxy Server for the VPC

FIG. 7 illustrates a diagram of VPC Proxy Server/Edge Server interactions with clients. Key features or problems solved can include:
The VPC Proxy Server is a Proxy Server sitting inside of the VPC.
   Who can connect to it?
      Clients inside of the VPC
      Proxy Server Clients outside of the VPC
The VPC Proxy Server acts as a gateway into and out of the VPC
   VPC Proxy Servers are the only things that should be reachable inside of the VPC from the outside.
      While actual configurations can vary, allowing non VPC Proxy Servers to be reachable from the outside is undesirable.
         The consequences would result in reduced security.
         Monitor software will be checking for these types of misconfigurations and will be triggering an alarm.
   VPC Proxy Servers are at the highest Cyber Risk in all the Unified VPC
      These systems require maximum network and system hardening.
         Everything that can be done to reduce the attack surface needs to be done.
         No password only access
         Systems need to be activity patched, including the firmware.
         All traffic in and out needs to be encrypted.
         Open ports limited to only what is required.
         Vulnerability scans (for example Vuls)
         Network scans (for example nmap)
         Audits of the system
         Automatic corrective action for incursion attempts (for example fail2ban)
         Automatic detection of possible incursion (for example tripwire)
         And anything else you can do you protect this server.
         If configured correctly, and hardened appropriately these systems will be the main line of defense.
         There should be redundant layers of defense to add additional security.
   These systems will route outgoing and incoming traffic.
      More details on that will be in a separate section of this document.
   There will also be a local firewall.
      The local firewall is there to additional layers of protection to the VPC local interfaces and the provider's firewall

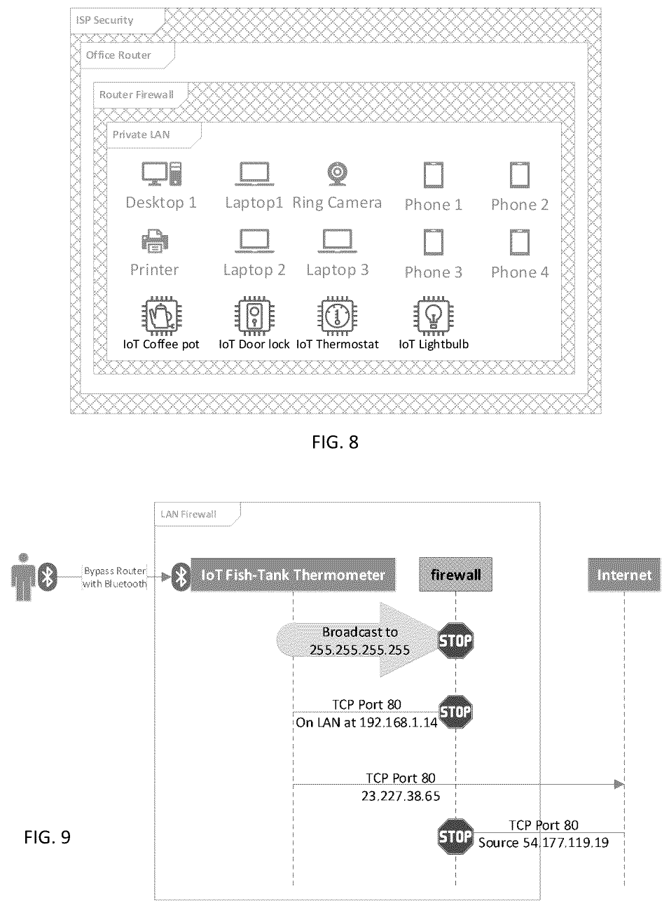

FIG. 8 illustrates a diagram of an office LAN. The problems encountered:
Every device on the LAN increases the attack surface.
You have limited control over some devices' security:
   An old printer, that has been EOL by its manufacturer, and no new firmware patches, with internet access could be a threat.
   The smart coffee pot with questionable security can be a threat.
   It has been reported that a casino was hacked using a Wi-Fi enabled fish-tank thermometer.
You want to connect the router to the Unified VPC, but doing so will increase the attack surface of the Unified VPC

FIG. 9 illustrates a diagram of a LAN firewall. Problems solved can include:
Using packet filtering on the router traffic can only go where you let it.
   In this case only traffic to 23.227.38.65
Drop packets due to firewall rule can be logged:
   Logged dropped packets can trigger a security alert.
      Someone may have compromised one of your IoT devices.
      Corrective actions like manually with automation can be taken:
         Rejecting all traffic from the device.
         Disconnecting it from Wi-Fi and blocking attempts to log into Wi-Fi

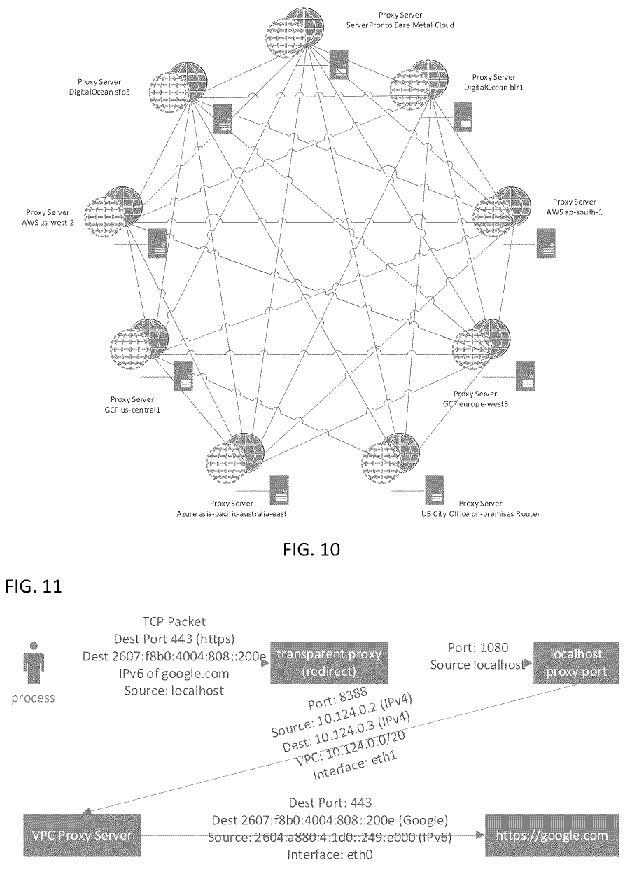

FIG. 10 illustrates a diagram of a unified network, in accordance with embodiments. Key features or problems solved can include:
All VPC Proxy Servers or LAN Proxy Servers can be connected.
   This connection of proxy servers creates encrypted routes data can travel on
LAN Proxy Servers should be behind a LAN firewall.
   LAN Proxy Servers can be installed on the LAN Router
      For example, on an openwrt, dd-wrt router, etc. . . . , more in a different section of this document.
These servers are the open systems that can have access to the internet.
   While these servers can have access, some supported configurations don't require that.
      For example, complex routing or where there are too many filter rules for a single system to handle. Worker proxy servers may be needed, and those may or may not need access to the internet.
All connections are encrypted with backup encryption.
   All traffic should be already encrypted (SSL, etc. . . . )
   All traffic going between servers will have an added level of encryption added.
All traffic destinations within the Unified Network will be routed.
   Details on routing will be in another section of this document.
All traffic will be filtered.
   For example: blacklisted destinations will be blocked.

FIG. 11 illustrates a flow diagram of routing to the internet, in accordance with embodiments. Key features or problems solved can include:

Dual Stacking of IPv4 and IPv6 supported.
a. Routing can switch between IPv4 and IPv6
   i. With will allow a transition from using only IPv4 to using only IPv6
b. White dual stacking is supported, using only IPv4 or IPv6 is supported.
   i. IPv4 for those who have not begun the transition to IPv6.
   ii. IPv6 for those who have transitioned to only IPv6.

Changes in source or destination IP addresses allowed if required.
c. Depending on how the VPC is setup, there may be private IP addresses and or a different interface for connections within the VPC.

For the destination server, they will only see the source IP address of the VPC Proxy Server
d. This adds lots of benefits.
   i. Allows you have a manageable number of IP addresses to add to whitelists.
      1. For example, you might use something like Jira or Bitbucket, you can add your list of VPC servers to the whitelist and now only people on your Unified VPC can access those sites.
   ii. It hides information about the host system

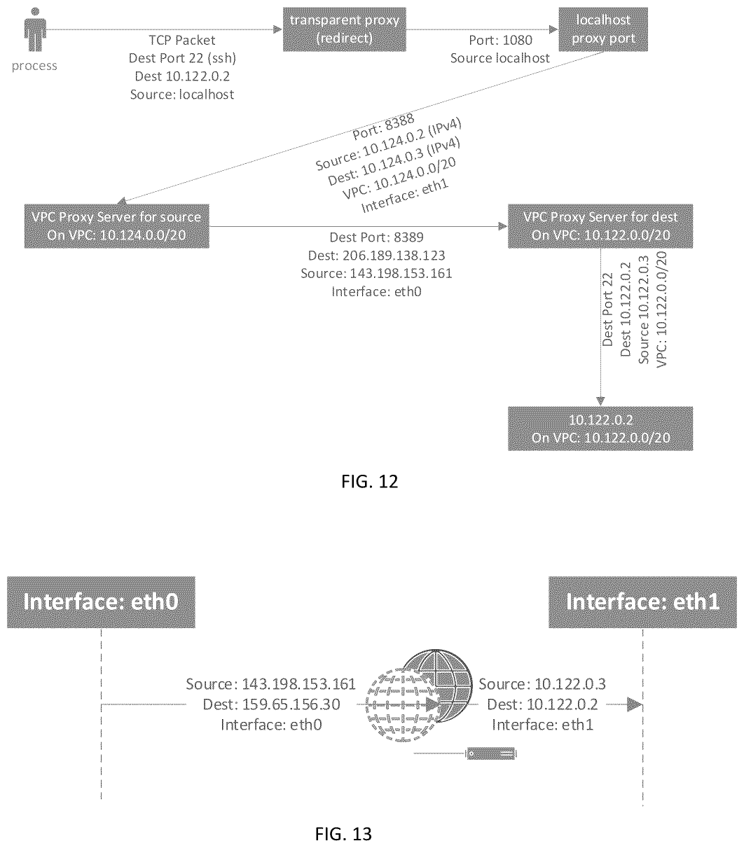

FIG. 12 illustrates a flow diagram of Routing to System inside of Unified VPC. Key features or problems solved can include:
Connections between systems on different VPCs will likely need to go across the open internet.
   Issues with traffic going across the open internet.
      Other people, systems, and network devices see your data.
         If your data is in clear text anyone in the path of your data can potentially
         Read it.
         Change your data in transit.
         Do a man in the middle attack.
      Especially during development, developments may not be using encryption.
         For example:
         They may have a webserver on port 80.
         They may be using a database that doesn't use encryption by default and hasn't enabled it yet.
      Mistakes or lack of training
         If everything is in the cloud mistakes or lack of training become a much better issue
         You are one junior developer away from a data breach, clear data moving across the internet can be sniffed.
To solve the problem of allowing the systems on the Unified VPC to talk with each other, keep the communication protected outside of the VPCs, and help maintain the integrity of the security required to protect the whole network.
   The Unified Network provides an encrypted network that private traffic can travel from one VPC to another VPC.
      Private Traffic is defined as traffic on the VPC, using whatever the Cloud Prover uses to keep the VPC private.
         For example: private IP addresses on a private subnet using a private interface.
To solve the problem of routing from one private network to another
   Each VPC Proxy has a transparent proxy server like on the client systems.
   Each VPC Proxy will have a list of public and private addresses for each VPC Proxy it is connected to.
      Public and Private IP addresses are supported, but using Public IP addresses is not recommended.
         Using only Private IP address ensures that connection stays within the Unified VPC
         If there is a misconfiguration, you will not be able to connect, but you won't have an unsecure connection.
         If a public IP address is used, and there is a misconfiguration that traffic may go on the open internet without the protection offered by the Unified VPC.
   When traffic comes into the VPC Proxy if will check against its list of addresses, if it has it in the list, the transparent proxy will redirect that to the local proxy port for the remote VPC Proxy Server (the server handling traffic for the destination system)
   On the source VPC Proxy the final-destination IP can be a public or private IP.
      The IP address won't be modified by the source VPC Proxy Server

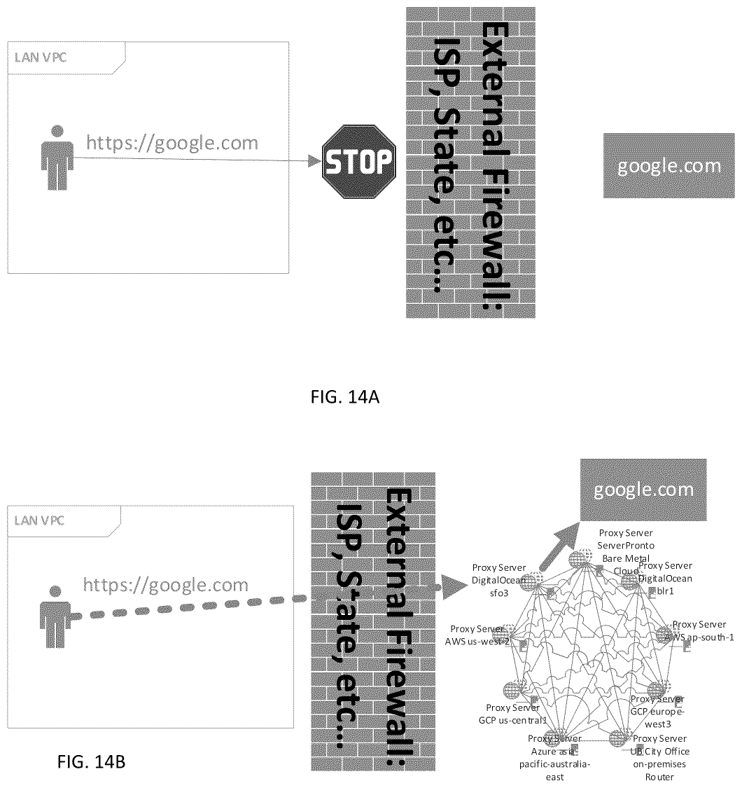

FIG. 13 illustrates a flow diagram of Routing/Interfaces. Key features can include:
The VPC Proxy for the destination IP may modify the IP address of the source and destination.
   Within a VPC there are provider firewalls and local system firewalls.
      The rules will most likely block traffic on public interfaces or public IP addresses.
      To get around these rules, the source and or destination IP addresses may be changed.
Once the traffic leaves the VPC Proxy goes until the destination and the local firewall for the destination

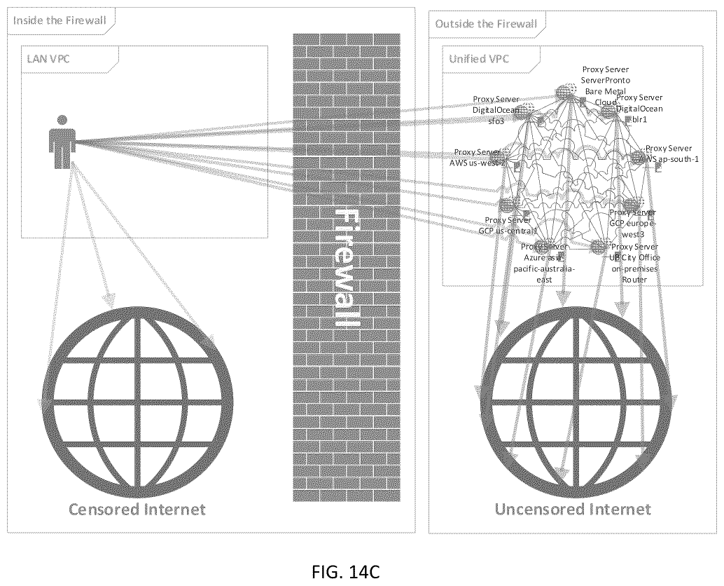

Additional supported configurations can be provided when specific data routes are required. Referring to FIG. 14A illustrates a flow diagram of a party being blocked by an external firewall. As seen in FIG. 14B, there may be use cases where direct internet routing is undesirable. A LAN VPC might be blocked from accessing something, due to being blocked by an external firewall.

Referring to FIG. 14C, illustrated is a flow diagram of a bypass with a single connection. The traffic can be directed to a VPC Proxy with access to the blocked site or outside of where the government can monitor. The Unified VPC can also accept connections from traditional VPN software or a VPN using proxies (and optionally configurations to help obfuscate or blend in with other traffic).

Detection migration. Additionally, you can configure the VPC to distribute traffic to any VPC Proxy Server you have access to, which may include third party VPC Proxy Servers for the purpose of distributing connection points for the purpose of internet access. Traffic to sites within the firewall can go direct, and outside can go to the distributed connections. A user can also run this in a distributed VPN mode, where all traffic will use the distributed connections. Additional steps can be taken to help obfuscate or blend in with other traffic. If anonymous and security connections are required, The Onion Router (Tor) can be used over our network.

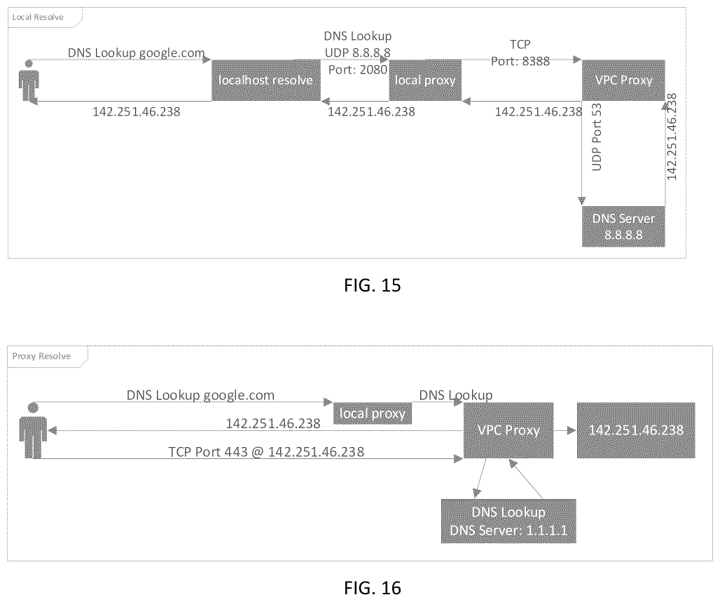

DNS Resolver. Referring to FIG. 15, illustrated is a diagram of local DNS resolution. Its features can include:
The localhost using local DNS config.
   In the above example, the local resolver makes a request using UDP on port 53 to a DNS server at 8.8.8.8 with the following steps:
      1. Since this is to a server outside of the VPC a request needs to be made using the VPC Proxy
      2. Since this request also requires UDP, the local UDP server port in 2080 will handle the request on the localhost.
      3. A call to the VPC Proxy using TCP will be made.
      4. The VPC Proxy will send the request using UDP to 8.8.8.8 at port 53.
      5. The VPC Proxy will send the response to the client.
      6. Finally, the local server will answer the resolver using UDP.

Referring to FIG. 16, illustrated is a diagram of remote DNS resolution. Based on the example in the figure, its features can include:
The lookup is done from on the VPC Proxy using its configuration.
   TCP request to 1.1.1.1 on port 53
   Optionally the local proxy can be configured to request a special DNS server.
      The VPC Proxy can override the requested server with its configuration.
The VPC Proxy will respond with the answer.

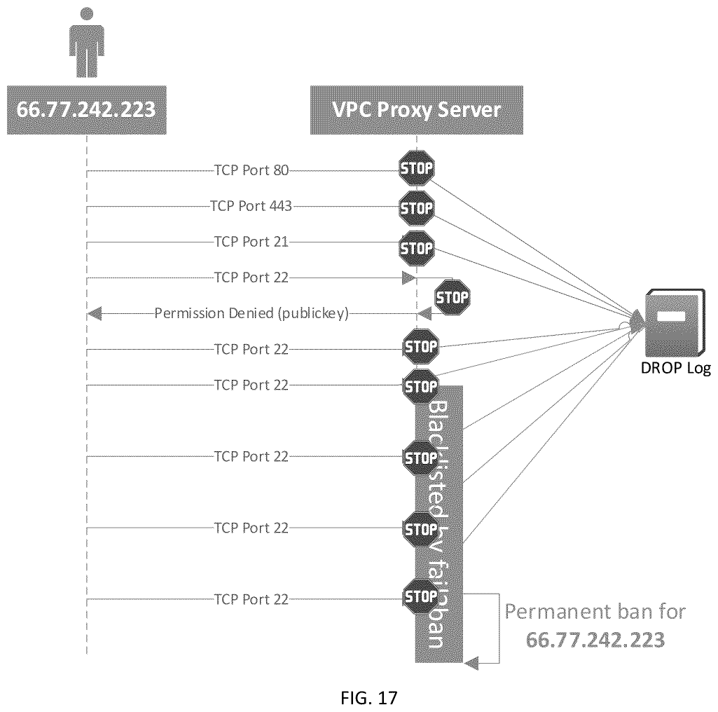

Referring to FIG. 17, illustrated is a diagram of a drop log. Drop, accept and other logs can be utilized. Its features can include:
Logs are important and will be monitored.
DROP logs:
   DROP and ACCEPT logs are normally not on default.
   DROP logs are helpful in a variety of situations.
      DROPs can be used to configure IoT devices on your network.
         You may not know what the IoT device needs to talk to, and the DROP logs can tell you what is being blocked.
         The Lightbulb needs to contact port 80 on 23.227.38.65
         Your computers trying to print to your printer need to use TCP Ports 80, 9100, and UDP Port 161.
         You can choice to approve or deny IoT connections.
      DROPs can be used to alert you to an IoT thermometer or anything else on the network that has been compromised.
      DROPs can tell you IPs are scanning your network or are scripts.

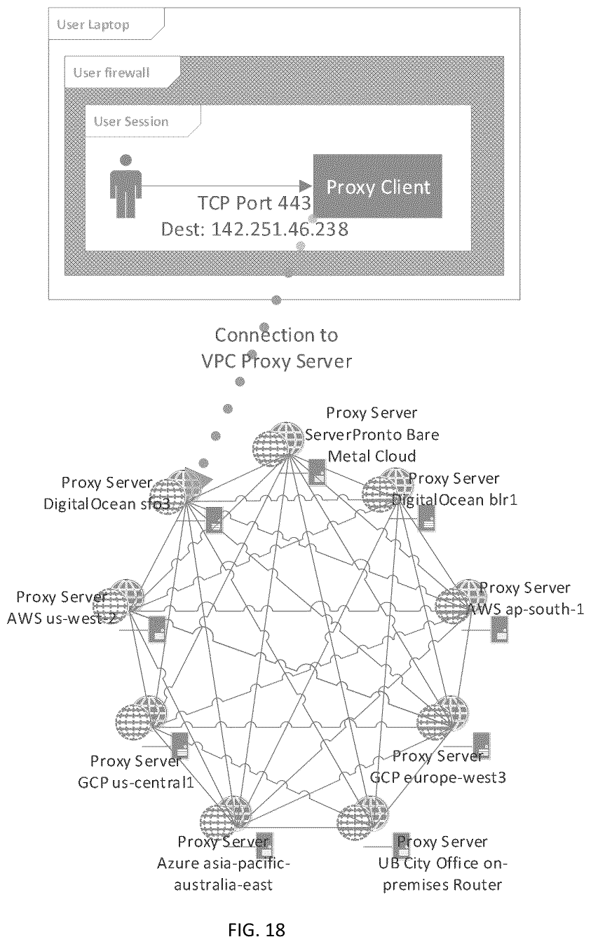

Referring to FIG. 18, illustrated is a diagram of end user connection into a unified VPC. Problems solved or Key features can include:
The problems
   The user at home needs to connect to things on the unified VPC.
   The Unified VPC needs to be protected from the user's system which may or may not be a managed system.
   The Unified VPC needs to be protected from things on the user's local area network.
The solutions
   Like the systems within the VPCs, the user can use a client to access the Unified VPC.
   Client connection configuration may vary depending on the need. Connection options include:
      A LAN with transparent proxy
      A client connecting a VPC Proxy Server and offering a local proxy connection.
         An online Proxy Auto-Configuration (PAC) file can help manage the global configuration, especial in cases VPC Proxy Servers are being used for whitelists in 3^{rd} party cloud apps.
      A VPN style connection where all traffic is routed to a single VPC Proxy server.
      Distributed VPN type connection where all traffic is routed to 2 or more VPC Proxy servers.
      Distributed proxy connection where some traffic is routed to 2 or more VPC Proxy servers.
   Defending the Unified VPC
      The ultimate defender of the Unified VPC will be the VPC Proxy Servers
      Addition layers should be configured in a way to add additional security, for example:
         Provider Firewalls
         Local Firewalls
         Use of private VPC connections.
         Controlled routing and network isolation
   The Internet of Things (IoT) problem
      There can be IoT devices that are on the network.
      IoT devices are a Major Cyber Risk and increase the Attack Surface.
      IoT devices can be managed with a LAN Transparent Proxy, which will be covered in greater detail in another part of this document.

Host TruVPC Client. The Host TruVPC Client would be a program and or collection of scripts (which will depend on the requirements of the host). The client will either be running continuously, run by reoccurring job (for example cronjob), or be run manually from the CLI. Key features can include:
Make contact the TruVPC API
Remote Monitor and Management
   Monitor, for example including, but not limited to:
      Network configuration
      Logs
      Usage information
      Installed Packages
      Results of commands run.
      Results of network commands
      Monitoring of drop packet logs
         Which can be used to see if an attack is in progress.
   Management, for example including, but not limited to:
      Ability to run commands potentially as root.
Zero Trust
   Client will not trust anything from the API without verification.
      A command on a system won't be run without verifying the API is who they say they are, verifying the API has permission to do what it wants, and verifying the command is still supposed to be run.
      Commands will be signed, and the signature will be verified.
   API will not trust client without verification.
      The API will need proof the host is who they say they are, this may go beyond having a valid key, information about the system maybe be required to verify the identity of host (things like, but not limited to, physical serial numbers electronically readable by the client, disk IDs, Ethernet address, Machine IDs, etc. . . . ).
      The API will also need to verify the host is allowed to do what the client is trying to do.
Local Client Configuration
   Including what the client will and will not allow on the host.
      For example, a production system may be configured to not allow the client to modify anything locally. Only monitor and if desired, generate a script that can be reviewed before being manually run by an administrator during a maintenance window.
Installer
   The Client will also come with an install to assist with the initial setup. The install will be able to be run with from the CLI and can be included in system build scripts.

LAN TruVPC Client. All the features of the host client, with the addition of the following. It can run on the router (or on a host), will be in an always running configuration and will always be able to make modifications to the router. Key features can include:
Active monitoring of drop packet logs
   Drop packets may be used to help configure new devices on the network.
      Example, you might not know what ports or hosts devices on the network need to talk to.
         Drop logs can show your lightbulb wants to talk to TCP Port 80 on 91.195.240.94
   Dropped packets may also be used as a warning of a compromised device.
The router may or may not have access to a VPC Proxy Server
   A router only configuration will be supported for home IoT security.
Partial Unified VPC connectivity can be configured.
   A user may want to use a device like a scanner or printer at their home, which a Virtual Desktop.
Full VPN access to the Unified VPC can be configured.
Described Proxy configuration can be configured.

Cloud TruVPC Client. The Cloud TruVPC Client would be a program and or collection of scripts (which will depend on the requirement of the host). The client will either be running continuously, run by reoccurring job (for example cronjob), or be run manually from the CLI. At least one Cloud TruVPC Client can be required for each supported provider in the Unified VPC. Key features can include:
Make contact the TruVPC API
Use the APIs available from each cloud provider for Remote Monitor and Management of the cloud services:
   Monitor, for example including, but not limited to:
      Get all information related to the VPCs.
      Get all information related to the firewalls.
      Get usage information.
      If available, get the current price for usage.
      Get a list of what services are being used and where.
   Management, if allowed, make changes with the providers APIs, for example including, but not limited to:
      Provisioning hosts, services, or resources
      Controlling hosts, services, or resources (for example restarting, shutdown/power off, and reimaging hosts)
      Destroying hosts, services, or resources (for example terminating and removing a virtual host)
      Making modifications to VPC configurations
      Making modifications to firewall configurations
      Making modifications to other cloud configurations

API and Database. Key Features can include:
The API will be how the client programs communicate with the cloud App and database.
Being exposed to the internet, the API is a high Cyber Risk
   The API will use a Zero Trust Security Model
      Authentication and Authorization will be checked with every call to the API.
   Where possible, Zero-knowledge proofs will be used, with the goal to confirm something without providing additional knowledge.
      Examples would include the use of Blockchain Databases, signed code, and signed commands.

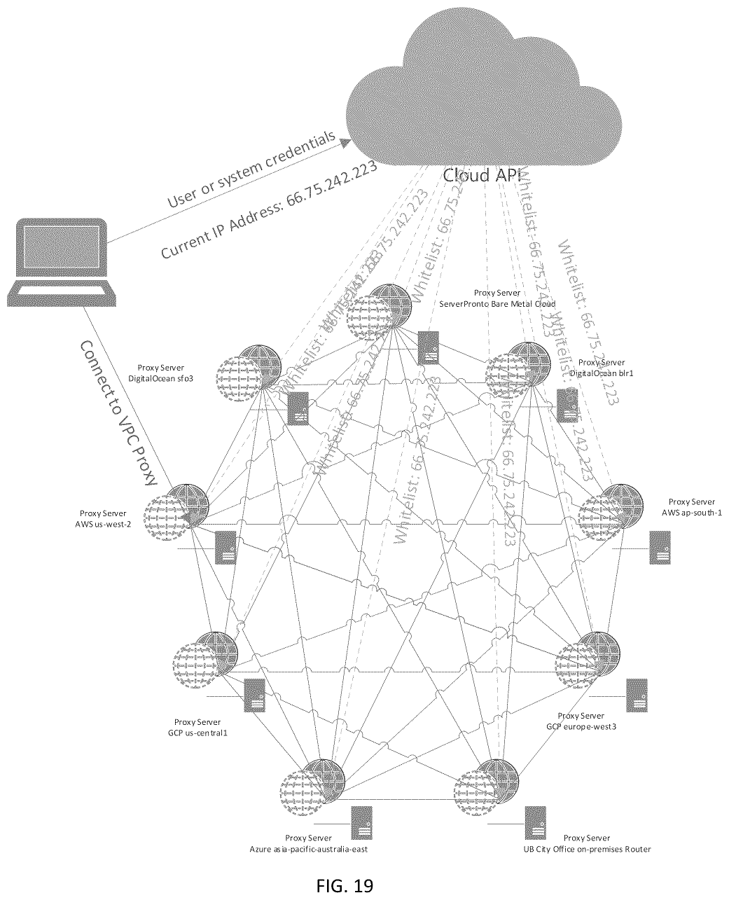

Automated and App Based Whitelisting. Referring to FIG. 19, illustrated is a diagram of whitelisting. Key features and problems solved can include:
Problem, anyone can attempt to access one of your Proxy Servers

### Solution

Whitelisting IPs
   Auto whitelisting. At boot or start of a session, an automatic call is made to Cloud API with credentials. Current IP is added.
      Auto call to API with host IP address changed.
      Previous IP addresses can be configured to auto remove or be timed out.
   Cloud App
      Manual whitelisting requiring authentication with Cloud Application
      Previous IP addresses can be configured to auto remove or be timed out.

TruVPC Cloud App. A TruVPC application can be available with an internet connection. The TruVPC Cloud App can be where TruVPC can be configured and monitored. It can be able to monitor and control anything within the control of TruVPC. A Problem can be encountered with fine grain cloud controls, some cloud providers offer only all or nothing access. It creates a situation where unapproved provisions can be made and can occur unapproved costs potentially with no limit to those costs. Nothing stops someone with approved access to request unapproved things. Key features and problems solved can include:

### Quotas

a. Allow super users the ability to grant quotas on resources.
b. Users with quotas can use apps or APIs to use or manage their quota.
   i. Example, a user may have quota for 3 Drop on Digital Ocean with up to 2 processors, 80 GB disk, not to exceed $30 a month each.
      1. User doesn't need to use quota and can request more quota or a special resource.
      2. Approval can follow the user's company's corporate process.
         a. For example: manager approval for up to $100, director for up to $500, above $500 required IT VP approval.
      3. User, if allowed, can reboot, reimage, or terminate/release the resource.

A problem that can be expected is with increased spending due to bug or other issue. In an example situation, an intern is testing scaling for something assigned to them. Before the test, Lambda Function with a configuration costing an estimated $18 for the month, is now going to have its scalability tested, the assigned task should increase the monthly estimated cost of this function to $40. Instead of going from 2,500,000 requests per month to 5,000,000 requests per month, due to a bug, they go to 5,000,000 requests per minute, with a new estimated cost of over $1 million for the month. Key features and problems solved can include:
Usage monitoring and price estimates
   Client software for hosts and clouds will monitor usage.
   Monitored usage will be used to estimate costs.
Limits, Alerts and automated corrective action
   Limits and rules for what happens can be configured:
      Example: A user limit based on total estimated cost
         At $100 estimated cost for the month send a warning email to the user
         At $200 estimated cost send a warning email to the user and their manager. Auto creates a P1 ticket.
         At $300 send repeating text messages and email to the user, their manager, and their VP. Auto escalate the existing P1 ticket.
         At $500 automated power off, shutdown, disable, or if necessary, delete, terminate, or destroy a resource. And send notify the CTO and CEO.

Another problem is with uncontrolled customer spend. In an example of the problem, a customer is attempting to use resources, and either is unaware of the cost or is intentionally using the maximum levels of resources available to them, with no intention of paying. Someone mining Cryptocurrency might try to use $1 million of compute but won't or can't pay the $1 million. The company running the TruVPC service would be on the hook for that money. A loss of that magnitude would be devastating to a lot of companies. Key features or problems solved can include:
Where possible, limits will be stated and enforced before provisioning the resource.
   With an option to request a higher limit
Using monitoring and prices estimates of TruVPC, rules can be defined to limit total spend.
   Like the feature limiting out of control user spend, similar rules can be applied to a company.
      At $500 start automated alerts, create a P1 ticket.
      At $750 start automated text messages, escalate P1 ticket, try to call customer.
      At $1000 shut down primary source for spending outside of the limits.
      At $1250, terminate all services, send a registered letter with the invoice.

Another problem can be with auto scaling, a need to monitor and predictively or reactively scale up or down.
Using the usage data available to TruVPC, auto scale resources based on defined policies.
   Considering customer settings and customer spending limits.

Allow the management of resources managed by TruVPC. Key features or problems solved can include:
A central to monitor and control everything managed by TruVPC.
Rules for health checks and compliance scores can be defined.
A map of the whole network to zoom in sections if desired.
   Flags for system or network health/compliance

Computer Emergency Response Team. For companies, organizations, or governments that require it, Computer Emergency Response Team controls are required. The problem is that there is a suspected attack or suspected incursion in process. Key features or problems solved can include:
Access to anything managed for the customer by TruVPC.
An interface that highlights suspected systems, networks or devices
   Highlight network path to point of entry if possible.
Access to controls that can allow the CERT team either be on defense, collect information, offense, or some combination of those.
   Allow them to do things like allow the connection, but isolate the everything in the path (using the firewalls block everything but the path), and detach access to anything sensitive (using cloud APIs remove disk volumes with sensitive data from the things under attack)
   Allow them to collect as much data as possible about whatever is conducting the attack.
   Allow them to access the drop logs from the firewall and see what the attacker is trying to do.
Allow them to disconnect and block access if the entry point has been determined.
Allow them to power off, shutdown, disable, or if necessary, delete, terminate, or destroy a resource.

Based on the foregoing, it can now be appreciated that a virtual private cloud technology (TruVPC) can support multiple direct connections anywhere (e.g., to/from different cloud providers) while ensuring data security and reducing risk of a single point of failure within the virtual private cloud network. Functioning like a virtual intranet, all data and functions are protected even where encryption is not utilized. Multiple forms of encryption can be utilized for data and transactions in/out of a TruVPC. Data can be spread out during transmission via the multiple connections, which speeds data transfer compared to restrictions encountered when using VPN (point to point) paths for data transfer. Without limitation, a TruVPC can provide:
Nested transparent gateways using packet filtering
Proxy Servers with connections to every other proxy server.
Choice of Ciphers, with AEAD Ciphers as the default
Choice of Heterogeneous Network Congestion Control with Hybla as default.
Compatible with 3^{rd} party tools like V2Ray (apart of Project V) to increase control over network privacy.

TruVPC is not simply based on VPN principles or standard network routing and gateway operations. Multiple direct connections provided by TruVPC are faster than single point-to-point connections utilized by VPNs. Multiple connections allow direct route of traffic. Routing with packet filtering using TruVPC provides more control over network paths. External and local firewalls can be used in combination with transparent proxies nested in TruVPC. Nested transparent proxies with the use of external and local firewalls removes risks associated with a single point of failure. Even if a user completely disables all packet filtering, firewalls, and other security, the server can remain secure.

TruVPC provides real-time Monitoring and management features. TruVPC can monitor and verify configurations given its complex use of nested transparent proxies and firewalls. Monitoring and verification of configurations can be achieved via port scans. Port scans are used as a form of testing to determine if all configurations line up with TruVPC protocols/settings. Testing can also determine if a firewall is functional (e.g., no open ports). The security is intended to be transparent, unobstructive, and tries to not give a user a reason to disable the security. If there is an attempt to disable security, incoming or outgoing access to anything outside of the VPC will be lost. Every aspect of a TruVPC configuration (e.g., server configuration, ISP configuration, user intended configuration) can be monitored in real-time.

Resource monitoring via data collected during monitoring, such as usage logs, can be utilized to minimize or eliminate costs by unintended causes (i.e., a bug in a script scaling resources above an expected amount). Auto shut-off procedures can be implemented to stop (by force if necessary) the resource with anomalous usage. Thresholds can be established in the TruVPC that triggers notifications or auto shut-off procedures. Specific servers or other devices can be targeted for shut-off when a threshold is met or exceeded for the servers/devices.

Vulnerability Scanning is also an operational aspect of monitoring to identify potential back doors in the TruVPC. IoT devices that are connected to a network associated with the TruVPC can cause a potential threat from outsiders attempting to access the network associated with the TruVPC. TruVPC can establish who devices on its network can talk to or what ports they can talk through.

Connections can be defined and monitored. Pairing attempts can be monitored. A notification can be provided remotely (e.g., to a phone app) so attempted connections can be approved. As connections are approved, a TruVPC can learn what can be identified as “authorized” connections. Connections can be established and learned in either direction (e.g., a monitored IoT system only talk one-way to a third-party monitoring company). Parties/connections can be whitelisted.

A TruVPC can be managed remotely via a variety of clients (e.g., smartphone app). A TruVPC assumes anyone from a developer to a cloud provider can do something in error to compromise security or creates charge overruns. A TruVPC has nested layers of tested protection (internal and external tests built into the product that don't require additional configuration), and is transparent (the developers don't need to do anything for everything to work). The install will do most of the things it looks like you need to use NetFoundry's Console. A TruVPC's Console will have a graphical representation of the entire network (including highlighting issues). An organization or private user can control the route of data if it wants (with point to point the default) and add layers of nesting (something for super enormous networks, but can also create sandboxes). A TruVPC can configure cloud network configurations. Basically, a TruVPC assumes the people/cloud providers an organization or personal user trusts are the biggest threat, and services like AppWAN/OpenZiti seems to assume the threat is external.

1. A method for setting up a virtual private cloud, Comprising:
providing redundant or nested security layers including a local firewall within a provider firewall;
providing a virtual private cloud proxy server with access to a data network through the local firewall and provider firewall;
configuring the virtual private cloud proxy server in coordination with the local firewall and the provider firewall to enable transparent proxying wherein TCP/UDP traffic is redirected to a local port, support interchangeable use IPV4 and IPV6, selectively allow access to all system within the provider firewall; and
providing access to a list of rules, whereby internet packet traffic is filtered and then directed to and from clients within the local firewall based on a list of rules.

2. The method of claim 1, wherein the list of rules includes at least one of:
selective use of IPV4 or IPV6;
protocol selection from at least one of TCP, UDP, ICMP, ICMPv6, UDP-Lite, ESP, AH, SCTP, MH;
receiving IP with or without a mask;
sending IP with or without a mask;
selection of destination port, source port or port range;
routing IP traffic to a next step or hop directly based on a rule from the list of rules;
routing IP traffic to a next step or hop directly based on a whitelist;
dropping IP traffic based on a blacklist.

3. A virtual private cloud, comprising:
a virtual private cloud proxy server with access to a data network;
redundant or nested security layers through which the virtual private cloud proxy server accesses the data network, the redundant or nested security layers including a local firewall within a provider firewall,
wherein the proxy server in coordination with at least one of the local firewall and provider firewall enables transparent proxying,
wherein TCP/UDP traffic is redirected to a local port;
wherein IPV4 and IPV6 is supported and usable interchangeably during transparent proxying;
wherein the proxy server and local firewall are configured to selectively allow access to all systems within the provider firewall; and
wherein internet packet traffic is filtered and then directed to and from clients within the local firewall based on a list of rules.

4. The system of claim 3, wherein the list of rules includes at least one of:
selective use of IPV4 or IPV6;
protocol selection from at least one of TCP, UDP, ICMP, ICMPv6, UDP-Lite, ESP, AH, SCTP, MH;
receiving IP with or without a mask;
sending IP with or without a mask;
selection of destination port, source port or port range;
routing IP traffic to a next step or hop directly based on a rule from the list of rules;
routing IP traffic to a next step or hop directly based on a whitelist;
dropping IP traffic based on a blacklist.
